(19) United States
(12) Patent Application Publication
(10) Pub. No.: US 2012/0265331 A1
(43) Pub. Date: Oct. 18, 2012

(54) FIVE-AXIS FLANK MILLING SYSTEM FOR MACHINING CURVED SURFACE AND THE TOOL-PATH PLANNING METHOD THEREOF

(75) Inventors: Chih-Hsing Chu, Hsinchu (TW); Hsin-Ta Hsieh, Hsinchu (TW)

(73) Assignee: NATIONAL TSING HUA UNIVERSITY, Hsinchu (TW)

(21) Appl. No.: 13/445,141

(22) Filed: Apr. 12, 2012

(30) Foreign Application Priority Data
Apr. 14, 2011 (TW) 100112915

(51) Int. Cl. G06F 17/50

(52) U.S. Cl. 700/103

(57) ABSTRACT

The invention discloses a five-axis flank milling system for machining curved surface and the method thereof, the system is capable of generating a tool path that minimizes the undercut error, overcut error, or the total machining error. The amount of the overcut, undercut, or total machining errors can be precisely controlled by adjustment of the cutter locations contained in a tool path. This invention is to transform tool path planning in five-axis flank milling into an optimal matching problem. The proposed mechanism of the invention significantly improves the manufacturing capability of five-axis flank milling. It enhances the machining quality by reducing various machining errors and provides a systematic approach to precise control of machining error in five-axis flank milling.

### BACKGROUND OF THE INVENTION

1. Field of the Invention

The present invention relates to a five-axis flank milling system for machining a curved surface and the tool-path planning method thereof. More particularly, the present invention relates to a five-axis flank milling system for machining a curved surface and the tool-path planning method thereof by utilizing global optimization methods that adjust the undercut and the overcut errors on the machined surface.

2. Description of the Prior Art

Five-axis machining is commonly used in aerospace, automobile, mold, and energy industries. Compared to traditional three-axis machining, five-axis machining provides additional freedoms in tool motion to shape complex geometries. In practice, five-axis machining operations can be classified into end milling process and flank milling process. In the end milling process, materials are removed by the tip of a cylindrical tool. In the flank milling process, materials are removed by the peripheral of the tool. Flank milling offers a faster material removal rate because of its larger tool contact. However, machining errors frequently occur in the flank milling process of complex surfaces.

Flank milling machining is normally used for machining of ruled surfaces. A simple way of tool path planning is to allow a cylindrical cutter to follow the rulings of a surface. Machining errors are produced when the surface is twisted, or locally non-developable in a technical term, around a ruling. The errors comprise the overcut machining errors and the undercut machining errors. The overcut machining errors are defined that the materials shall not be removed but removed by the cutter. The undercut machining errors are defined that the materials shall be removed but not removed by the cutter.

Most previous arts adopted heuristic approaches to reducing machining errors in five-axis flank milling. These approaches were applied to adjust individual cutter locations independently, without considering the tool motion between cutter locations or the machining errors thus occur. The tool path generated in this manner fails to produce minimal machining errors. This problem can be overcome by simultaneous adjustment of all cutter locations through global optimization. Accordingly, Taiwan Patent Application No. 96147909 is to provide such a tool path planning method. This patent discloses a five-axis flank milling method based on global optimization of all cutter locations at the same time. This method can automatically calculate a tool path that minimizes the total errors on the machined surface. It also provides a method to precisely control the machining errors.

In most applications, the damage/loss induced by the undercut error is different from that by the overcut error. A secondary machining can be applied to remove the material left with undercut, while the overcut error is often not remediable. In prior art, all the tool-path planning methods cannot control specifically the overcut or the undercut errors on the machined surface. Thus, the practical value of those methods is limited.

### SUMMARY OF THE INVENTION

A scope of this invention is to provide a five-axis flank milling system for machining a curved surface and the tool-path planning method thereof More specifically, the present invention relates to a five-axis flank milling system for machining a curved surface and the tool-path planning method thereof by utilizing global optimization methods that minimize the total error, the undercut error, or the overcut error on the machined surface by simultaneously adjusting individual cutter locations.

According to the embodiment of this invention, the five-axis flank milling system computes a tool path to machine a curved surface of a workpiece and thus generates a machined geometry in accordance with design specification. The five-axis flank milling system comprises a computing module, an analyzing module, an interface module and a processing module.

Wherein, the computing module is applied to select a group of measuring points from the curved surface, and generate a straight line along the surface normal direction for each measuring point. This module thus transforms stock material from a volumetric representation into discrete straight lines. The cutter intersects these lines while it is moving along a tool path. The length of each intersected line is updated, thus approximating the machined shape.

The analyzing module is coupled to the computing module for calculating the overcut error, the undercut error, and their sum as the total machining error. The processing module is coupled to the analyzing module for calculating the tool path by a global optimization algorithm with the total machining error as an objective.

In practice, the five-axis flank milling system comprises an adjusting module and an interface module. The interface module is coupled to the processing module for users to input weights for undercut and overcut, respectively. The adjusting module is coupled to the interface module for adjusting the global optimization algorithm with the input weights.

In practice, the optimization algorithm is a genetic algorithm or a particle swarm optimization algorithm. Additionally, the overcut weight or the undercut weight is a positive value.

Another scope of the invention is to provide a tool path planning method of the five-axis flank milling system that computes consecutive cutter locations for machining a curved surface of a workpiece in accordance to design specification. The tool-path planning method comprises the following steps of: (S1) selecting a group of measuring points on the curved surface; (S2) generating a straight line along the surface normal at each measuring point; (S3) prompting users to input weights for undercut and overcut respectively; (S4) computing an initial solution as the current tool path; (S5) importing consecutive cutter locations defining the current tool path; (S6) producing intermediate cutter positions by linear interpolation; (S7) calculating the length of each intersected line; (S8) estimating the undercut, overcut, and total machining errors by adding up the lengths of all the lines; and (S9) computing the next tool path by a global optimization algorithm with the total machining error as an objective and returning to (S5) if the objective value has not converged yet.

Wherein, the optimization algorithm can be a genetic algorithm or a particle swarm optimization algorithm. Additionally, the overcut weight or the undercut weight is a positive value.

In prior art, the tool-path planning methods in five-axis flank milling of curved surface reduce the machining error by trial and error. In this invention, the total machining error is adopted as the objective in a global optimization method that systematically minimizes the machining error through iterations. Additionally, a better solution is computed from previous solutions at each iteration. Thus, the machining error produced by the tool path can be precisely controlled.

Furthermore, the tool path planning method is highly flexible. The objective function can be defined as the overcut error, the undercut error, or the total machining error by giving appropriate weights to undercut and overcut.

The advantage and idea of this invention may be demonstrated by the following recitations together with the appended drawings.

### BRIEF DESCRIPTION OF THE APPENDED DRAWINGS

FIG. 1 illustrates a functional block diagram of the five-axis flank milling system for machining curved surface according to an embodiment of the invention.

FIG. 2 illustrates a flow chart of the tool-path planning method according to an embodiment of the invention.

FIG. 3A illustrates a schematic diagram of the step (S1) of the tool-path planning method of the invention.

FIG. 3B illustrates a schematic diagram of the step (S2) of the tool-path planning method of the invention.

FIG. 3C illustrates a schematic diagram of the step (S3) of the tool-path planning method of the invention.

FIG. 3D illustrates a schematic diagram of the step (S4) of the tool-path planning method of the invention.

FIG. 3E illustrates a schematic diagram of the step (S5) of the tool-path planning method of the invention.

FIG. 4 illustrates an encoding scheme of the step (S5) of the tool-path planning method of the invention.

FIG. 5 illustrates the simulation results with various conditions of the minimization of the overcut, undercut and the total machining errors.

### DETAILED DESCRIPTION OF THE INVENTION

The word “undercut” or “undercut error” indicates that a part of workpiece shall be removed but not removed by the tool in machining. The word “overcut” or “overcut error” indicates that a part of workpiece shall not be removed but removed by the tool in machining.

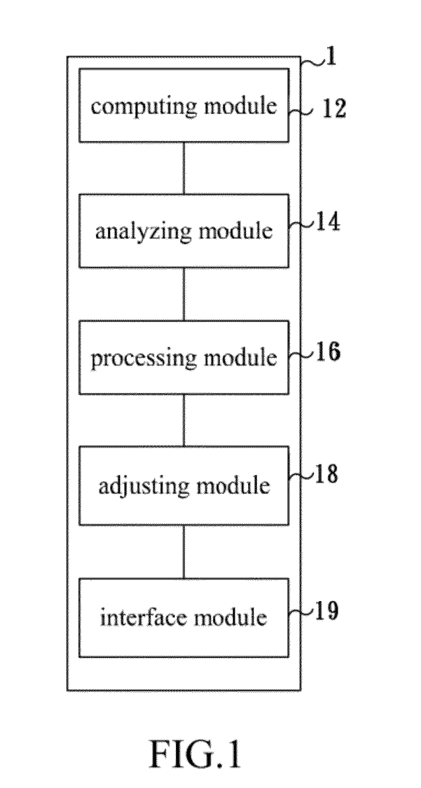

Please refer to FIG. 1. FIG. 1 illustrates a functional block diagram of the five-axis flank milling system for machining curved surface according to an embodiment of the invention. The five-axis flank milling system 1 is applied to compute and generate a tool path for machining a curved surface of a workpiece and generating an machined surface 2 in accordance to design specification. In the embodiment, the five-axis flank milling system 1 comprises a computing module 12, an analyzing module 14, an interface module 16, an adjusting module 18 and a processing module 19.

The computing module 12 is utilized to select a group of measuring points 22 of the curved surface 2 and generate a straight line 24 along the surface normal at each measuring points 22 of the curved surface 2.

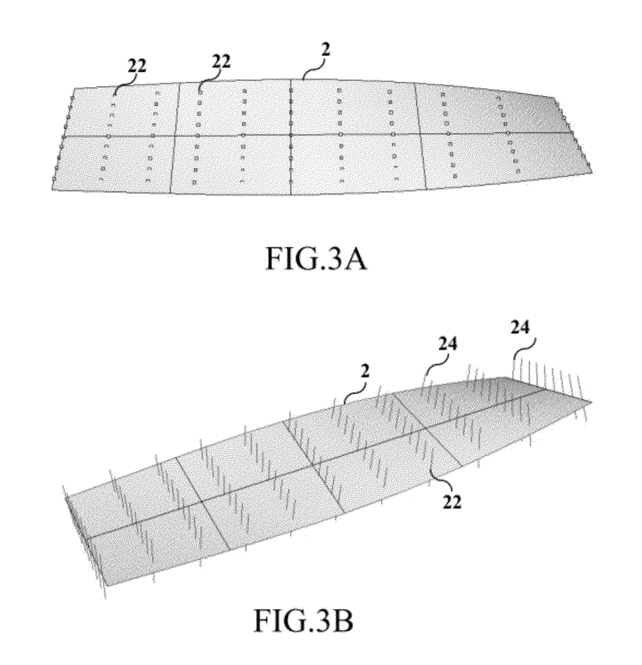

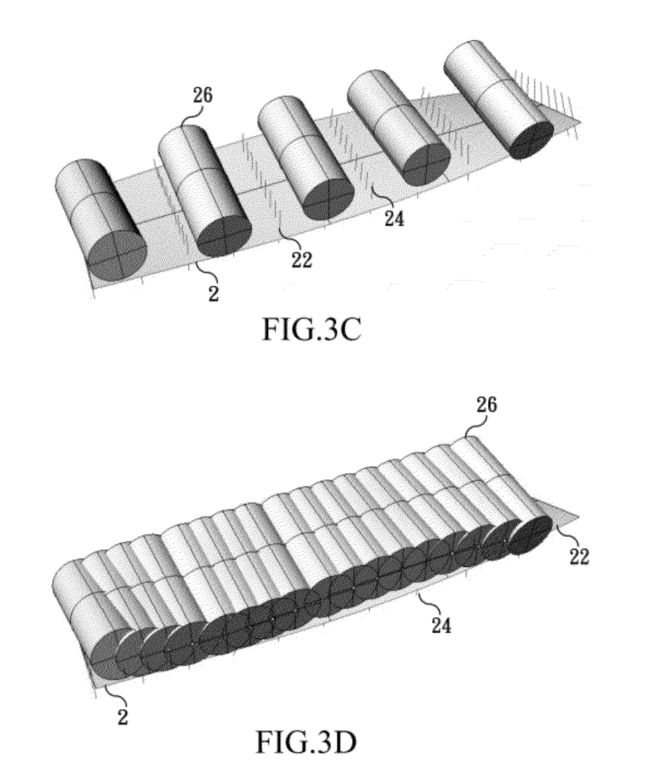

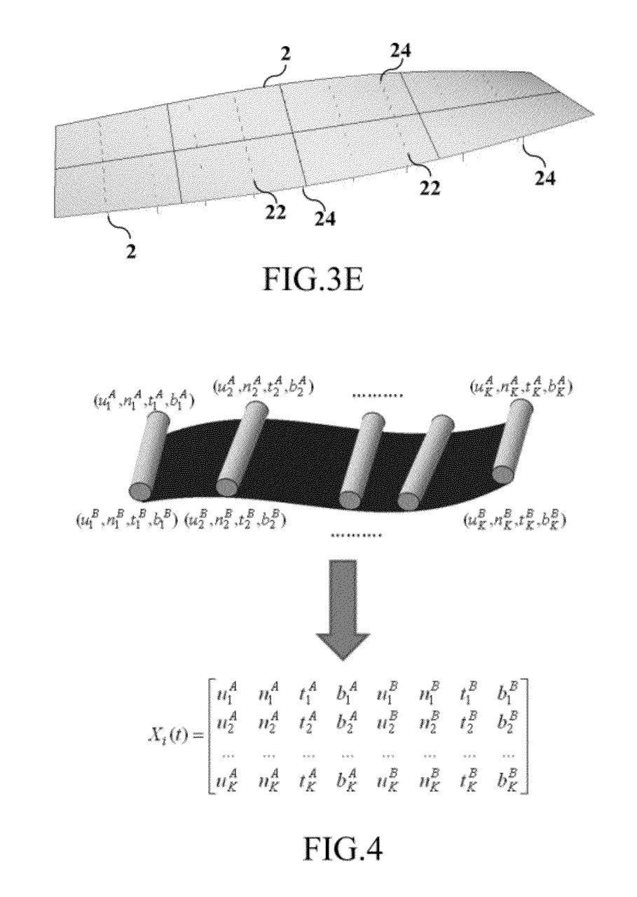

The analyzing module 14 is coupled to the computing module 12 for calculating the length of each line intersected by the tool 26 at one cutter location. As shown in FIG. 3D, intermediate cutter positions are generated by linear interpolation of any consecutive cutter locations. The total machining error can be obtained by summing the lengths of all the remaining lines after the machining.

The processing module 19 is coupled to the analyzing module 14 for computing the tool path by a global optimization algorithm with an objective as to minimize the total machining error. The interface module 16 is coupled to the processing module 19 for a user to input an overcut weight and an undercut weight. In the embodiment, the interface module 16 can be a data input device, a data output device, or a device integrated with the input device and data output device. The data input device can be a keyboard, a key, or other devices or modules which allows the user to input data to the five-axis flank milling system 1. The data output device can be a display or other devices or modules which can output the data.

The adjusting module is coupled to the interface module for adjusting the global optimization algorithm with the input weights. Wherein, the computing module 12, the analyzing module 14, the processing module 19 or the adjusting module 18 can be an electronic device or an electronic element which can process the data. However, the electronic device or the electronic element can be, but not limited to be set separately. In the embodiment, the computing module 12, the analyzing module 14, the processing module 19 and the adjusting module 18 are integrated in to a central processing unit.

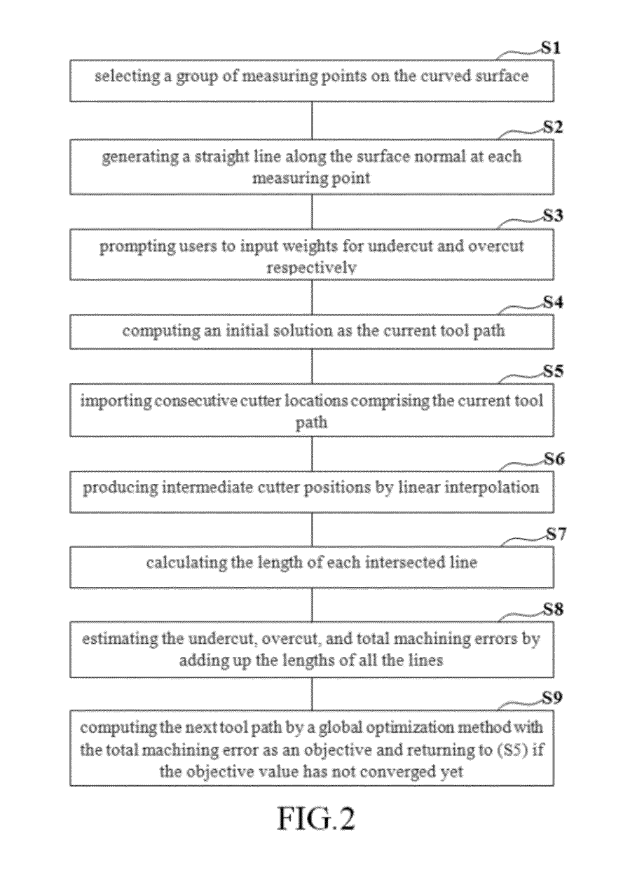

Please refer to FIG. 2. FIG. 2 illustrates a flow chart of the tool path planning method according to an embodiment of the invention. The tool path planning method is applied to compute a group of cutter locations 26 that comprise a tool path for machining a curved surface 2 of a workpiece. The tool path planning method comprises the following steps of: (S1) selecting a group of measuring points on the curved surface; (S2) generating a straight line along the surface normal at each measuring point; (S3) prompting users to input weights for undercut and overcut respectively; (S4) computing an initial solution as the current tool path; (S5) importing consecutive cutter locations defining the current tool path; (S6) producing intermediate cutter positions by linear interpolation; (S7) calculating the length of each intersected line; (S8) estimating the undercut, overcut, and total machining errors by adding up the lengths of all the lines; and (S9) computing the next tool path by a global optimization method with the total machining error as an objective and returning to (S5) if the objective value has not converged yet.

Please refer to FIG. 3C to FIG. 3E. FIG. 3A to FIG. 3E illustrate a schematic diagram of the step (S1) to the step (S5) of the tool path planning method of the invention. The step (S1) is to select a group of measuring points 22 from the curved surface 2. Then, the step (S2) is to generate a straight line 24 along the surface normal at each measuring point 22. Wherein, the straight line 24 emanates to both sides of the curved surface 2 for approximating the stock material corresponding to the overcut and undercut errors.

Then, the step (S3) is to prompt the user to input a weight for the undercut and overcut errors respectively in the objective function adopted by a global optimization method. These two weights are positive values.

Then, the step (S4) is to generate an initial solution of the tool path. Wherein, a way of determining the initial solution is to let the cutter follow the rulings of the curved surface 2; or to slightly perturb the cutter locations from contacting the rulings.

The step (S5) is to import consecutive cutter locations that comprise the current tool path. Wherein, the number of cutter locations is given by the user.

Then, the step (S6) is to generate intermediate tool positions between any consecutive cutter locations. Wherein, a certain number of tool positions are linearly interpolated from any two consecutive cutter locations. More specifically, an intermediate tool position is determined by linear interpolation of the cutter center and the cutter axis at the cutter locations. Additionally, the number of the interpolated tool positions is controlled by the user.

The step (S7) is to calculate the length for all the lines generated from the curved surface 2. Wherein, these lines may be intersected by the cutter moving between the tool positions generated in the step (S6). This calculation is to be conducted for all the tool motions along the current tool path.

The step (S8) is to estimate the undercut, overcut, and total machining errors by adding up the lengths of all the lines after machining, as illustrated in FIG. 3E. Wherein, the total machining error is the sum of the undercut and overcut errors.

The step (S9) is to compute next tool path by a global optimization method with the total machining error as an objective. Wherein, the global optimization method can be a genetic algorithm or a particle swarm optimization algorithm. Additionally, if the objective value has converged judged by a stop criterion given by the user, the procedure terminates; otherwise returns to the step (S5).

The total machining error is a weighted sum of the overcut and the undercut errors as:

Total error=Wₒ*SumGouge+Wᵤ*SumExcess

Wherein, Wₒ and Wᵤ are the weights for overcut and undercut respectively. SumGouge is the sum of the overcut errors at all measuring points 22. SumExcess is the sum of the undercut errors at all measuring points 22.

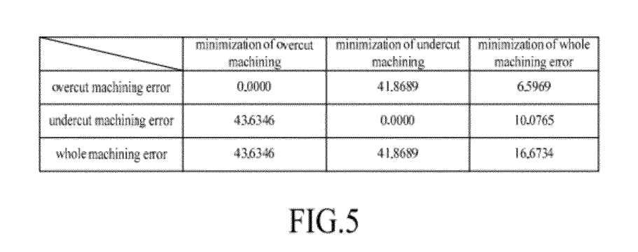

FIG. 4 illustrates an encoding scheme for the optimization algorithm used by the tool path planning method of the invention in the step (S9). The particle swarm optimization algorithm is used in the invention as an example and each parameter and variable in the algorithm are shown as follows:
X_{gb}(t): global optimal location;
f_{gb}(t): he objective value of X_{gb}(t);
X_{ib}(t): the optimal location of particle i in one iteration;
f_{ib}(t): the objective value of X_{ib}(t);
Xᵢ(t): the location of particle i at time t;
fᵢ(t): the value of Xᵢ(t);
Vᵢ(t): the velocity of Xᵢ(t);
W: weight
C₁, C₂: learning factor
rand₁, rand₂: random numbers generated from the probability distribution of U(0,1)
N: the population of particles;
T: the number of iterations;

The location of a particle Xᵢ(t) corresponds to a tool path consisting of n cutter locations. The encoding of each cutter location contains four pairs of variables: uᵢⱼ, tᵢⱼ, nᵢⱼ, and bᵢⱼ. (Please refer to FIG. 4) Each tool path produces an objective value, the total machining error fᵢ(t). The initial velocity of particle i is chosen as null. The search process of PSO is described as follows:

Vᵢ(t+1)=W×Vᵢ(t)+C₁×rand₁×(X_{ib}(t)−Xᵢ(t))+C₂×rand₂×(X_{gb}(t)−Xᵢ(t))

Xᵢ(t+1)=Xᵢ(t)+Vᵢ(t)

0≦t≦(T−1), rand₁˜U(0,1), rand₂˜U(0,1), i=1,2, . . . N

Wherein, W, C₁, and C₂ are constants to be chosen by the user.

The algorithm consists of the following steps: (T1) N sets of tool path are randomly generated from uniform distribution. Each path corresponds to the location of a particle Xᵢ. The initial velocity Vᵢ(0) is null. We obtain the minimal value X_{gb}(0) by computing the machining error produced by each particle; (T2) we compute Xᵢ(t), Vᵢ(t), and fᵢ(t) for each particle based on the equation shown above. f_{ib}(t) is replaced with the smaller between f_{ib}(t) and the error. The same update is applied to f_{gb}(t), too; (T3) the process terminates after T times of iteration; otherwise it repeats the step (T2).

Simulation software NC Vericut™ is used to verify this invention. Please refer to FIG. 5. FIG. 5 illustrates the estimated errors with various conditions of minimization of the overcut, undercut or the total machining errors as an objective function in the global optimization method. As shown in FIG. 5, when the objective is to minimize the overcut errors, with a large overcut to undercut weight ratio, the overcut error approaches zero. The same result is obtained vice versa.

With the example and explanations shown above, the effectiveness and idea of the invention are well elucidated. The above disclosures should be construed as limited only by the metes and bounds of the appended claims.

What is claimed is:

1. A five-axis flank milling system for generating a tool path to machine a curved surface of a workpiece in accordance to design specification, comprising:
a computing module applied to select a group of measuring points from the curved surface and generate a straight line along the surface normal at each measuring point;
an analyzing module coupled to the computing module for calculating the length of each line intersected by a tool at a cutter location and generating a given number of intermediate cutter positions by linear interpolation of any consecutive cutter locations;
a processing module coupled to the analyzing module for computing the tool path by a global optimization algorithm with an objective as to minimize a total machining error;
an interface module coupled to the processing module for a user to input an overcut weight and an undercut weight; and
an adjusting module coupled to the interface module for adjusting the global optimization algorithm with the input weights.

2. The five-axis flank milling system of claim 1, wherein the overcut weight or the undercut weight is a positive value.

3. The five-axis flank milling system of claim 1, wherein the optimization algorithm is a genetic algorithm or a particle swarm optimization algorithm.

4. A tool path planning method of a five-axis flank milling system computing a given number of cutter locations defining a tool path for machining a curved surface of a workpiece, comprising the following steps of:
(S1) selecting a group of measuring points on the curved surface;
(S2) generating a straight line along the surface normal at each measuring point;
(S3) prompting a user to input weights for undercut and overcut respectively;
(S4) computing an initial solution as the current tool path;
(S5) importing consecutive cutter locations defining the current tool path;
(S6) producing intermediate cutter positions by linear interpolation;
(S7) calculating the length of each intersected line;
(S8) estimating the undercut, overcut, and total machining errors by adding up the lengths of all the lines; and
(S9) computing the next tool path by a global optimization algorithm with the total machining error as an objective and returning to (S5) if the objective value has not converged yet.
